(19) United States
(12) Patent Application Publication
(10) Pub. No.: US 2002/0134448 A1
(43) Pub. Date: Sep. 26, 2002

(54) Locatable magnetic polyethylene gas pipe distribution system

(76) Inventor: William L. Goodman, Los Altos Hills, CA (US)

Correspondence Address: Pauley Petersen Kinne & Fejer, Suite 365, 2800 W. Higgins Road, Hoffman Estates, IL, 60195, US

(21) Appl. No.: 09/945,568

(22) Filed: Aug. 30, 2001

Related U.S. Application Data
(60) Provisional application No. 60/229,276, filed on Aug. 30, 2000.

(51) Int. Cl. F16L 55/00

(52) U.S. Cl. 138/104

(57) ABSTRACT

A locatable gas distribution system having magnetic polyethylene (PE) pipe with ferrite particles embedded within the polyethylene. The magnetic polyethylene pipe has a magnetic pattern signature with a constant magnitude and a constant change in a direction along a length of the pipe.

### BACKGROUND OF THE INVENTION

1. Field of the Invention

This invention relates to a magnetic polyethylene (PE) gas pipe distribution system. More specifically, this invention relates to a magnetic PE pipe system wherein an optimum concentration by weight of ferrite particles is compounded with conventional grade PE resins to provide magnetic PE pipe which is locatable at typical burial depths without sacrificing the integrity and long-term durability of the pipe.

2. Description of the Prior Art

Gas pipes that cannot be conveniently and reliably located are a serious concern to owners as well as to excavators. One conventional means of locating polyethylene (PE) pipe requires placing a thin copper tracer wire alongside the PE mains during underground installation of the gas pipe system. A radio signal is induced onto the tracer wire either at a gas service riser or at a connection box installed at ground level. A hand-held receiver or locator is moved across the presumed location of the pipe until a peak signal intensity is obtained.

Tracer wires serve only to help in determining the location of a gas main prior to excavation. The added labor and material incurred by burying the tracer wire result in substantial additional expense to gas companies. Further, although tracer wire systems have been found to be fairly reliable, breaks do occur which can lead to inaccurate pipe locating. If the tracer wire is damaged, for example corrodes, while in service, the plastic main may not be accurately or continuously locatable, and thus will be vulnerable to further damage. The cost of third party damage resulting from inaccurate plastic pipe location is approximately $12.0 million annually, and this cost continues to increase as the use of plastic piping materials increases.

Alternatives to using the conventional tracer wire technique to help locate PE pipe include more effective ground penetrating radar and other highly advanced approaches for location purposes such as Automated Mapping/Facilities Management (AM/FM) systems. However, these alternatives require costly implementation and are not “field friendly.” Thus, there is a need for an intrinsically to locatable system that can be readily detected in “real-time” during actual construction.

In accordance with this invention, a commercially viable and user friendly magnetic PE pipe system has been developed that is accurately and reliably locatable at typical burial depths without sacrificing the integrity and long-term durability of the pipe. The use of magnetic PE pipe greatly reduces the instances of inaccurate pipe locating, thereby reducing the incidence of third party damage and the costs associated with repairs.

### SUMMARY OF THE INVENTION

It is an object of this invention to provide a gas distribution system wherein the buried gas pipes are permanently locatable thereby reducing third party damage, reducing installation and maintenance costs, and increasing the safety and reliability of the gas distribution system.

It is another object of this invention to provide an effective and more reliable method for detecting and locating an underground magnetic polyethylene gas pipe forming a portion of the gas distribution system.

It is another object of this invention to provide magnetic polyethylene pipe material for use in a locatable gas distribution system.

It is another object of this invention to provide a method for producing magnetic polyethylene pipe material for use in the locatable gas distribution system.

A detectable or locatable underground gas distribution system according to one preferred embodiment of this invention includes a pipe formed of a thermoplastic material, preferably a polyethylene resin material, having a plurality of ferrite particles embedded in the thermoplastic material. Preferably, the ferrite particles include at least one of strontium ferrite and barium ferrite. It is apparent to those skilled in the art that other ferrite particles may be appropriate for use in the underground locatable gas distribution system according to this invention.

The ferrite particles are magnetized to form a magnetic pattern signature on at least a surface of the pipe having a substantially constant magnitude and a change in direction along a length of the pipe. Preferably, but not necessarily, the magnetic pattern signature is a sinusoidal signature having a constant predetermined periodicity, for example 10 feet.

A method for detecting and/or locating underground magnetic polyethylene (PE) gas pipe according to one preferred embodiment of this invention includes embedding into a polyethylene gas pipe a plurality of ferrite particles, for example strontium ferrite particles and/or barium ferrite particles. In one preferred embodiment of this invention, the ferrite particles are embedded into the polyethylene gas pipes by extruding a mixture of ferrite particle powder and polyethylene powder or resin. Preferably, the mixture of ferrite particle powder and polyethylene powder has a ferrite particle powder concentration up to about 30%, more preferably about 12% to about 24%, and still more preferably about 17% to about 24%.

The ferrite particles embedded into the polyethylene gas pipe are then directionally magnetized, preferably using a permanent magnetizer unit, to impose on m at least a surface of the pipe a magnetic pattern signature having a substantially constant magnitude and a generally uniform change in direction along a pipe length. In one preferred embodiment of this invention, the embedded ferrite particles are magnetized using a magnetizer having a plurality of magnets which are rotatable about a bore formed in the magnetizer having a circumference slightly larger than an outer circumference of the polyethylene pipe. The polyethylene pipe travels or is moved through the bore formed in the magnetizer, wherein the plurality of permanent magnets rotating about the circumference of the polyethylene gas pipe magnetize the embedded ferrite particles, whereby forming a magnetic pattern signature along the length of the pipe.

In one preferred embodiment of this invention, the magnetizer comprises a modified Halbach dipole. Preferably, a magnetic field produced within the bore formed by the magnetizer measures at least about 6000 gauss. The magnets are preferably niodynium-iron-boron magnets. However, other magnets, apparent to those having ordinary skill in the art, having appropriate magnetic properties and the required strength may also be used.

Once buried underground, magnetic polyethylene gas pipe can be located using a location device which measures a magnetic field magnitude and the change in direction of the magnetic field along the length of the pipe. Preferably, the location device is a hand-held device comprising a three-orthogonal sensor.

Three fundamental issues must be considered in order to balance the conflicting needs for minimizing additional production costs, maintaining strength and durability, and maximizing in-service detectability. The optimum magnetic particle concentration level must be determined such that the physical, chemical and mechanical properties of the extruded PE pipe are not compromised. Further, the sinusoidal signature must be effectively detectable at typical burial depths (3 feet for main lines and 18 inches for service lines) in both cluttered (downtown and urban areas) and uncluttered environments (suburban and rural areas), for example. Through a series of comprehensive laboratory and field evaluations, the final formulation for an intrinsically locatable PE piping system has been identified.

It is generally recognized that the common modes of failure for plastic gas distribution pipes include short-term ductile rupture and long-term slow crack growth (SCG). Currently, there are approximately sixty various ASTM test methods that address the physical, mechanical and chemical properties of plastic pipe. The cumulative results of each of these tests help to characterize the structural integrity of the pipe in terms of its ability to withstand the stresses caused by internal gas pressure and to prevent leakage through the pipe wall and joints.

Three individual lots of magnetic PE pipe manufactured in accordance with preferred embodiments of this invention, including medium density polyethylene (MDPE) pipe and high density polyethylene (HDPE) pipe at two different concentration levels of ferrite particles, were subjected to comprehensive testing and evaluation per ASTM D2513-99 specifications.

The results of the comprehensive testing and evaluation indicate that there are no adverse effects of introducing ferrite particles up to 24% concentration by weight within conventional grades of polyethylene resin. Further, the magnetic PE pipe can be readily located in both rural and urban environments at typical burial depths and in the presence of surrounding background clutter.

### BRIEF DESCRIPTION OF THE DRAWINGS

The above-mentioned and other features and objects of this invention will be better understood from the following detailed description taken in conjunction with the drawings wherein:

FIG. 1 is a perspective view of a locatable magnetic polyethylene (PE) pipe, according to one preferred embodiment of this invention;

FIG. 2 is a schematic illustration of an extrusion line having a magnetizer, according to one preferred embodiment of this invention;

FIG. 3 is a schematic perspective view of a magnetizer, according to one preferred embodiment of this invention; and

FIG. 4 is a plan view of a magnetizer, according to one preferred embodiment of this invention.

### DESCRIPTION OF PREFERRED EMBODIMENTS

An intrinsically detectable or locatable gas distribution system 10, in accordance with preferred embodiments of this invention, comprises magnetic polyethylene (PE) gas pipe 15 permanently locatable, thereby reducing third party damage, reducing cost and increasing the safety and reliability of gas distribution system 10.

Gas distribution system 10 in accordance with this invention provides a means for balancing the need for minimizing additional manufacture and production costs, maintaining strength and durability, and maximizing in-service detectability. Magnetic PE gas pipe 15, in accordance with preferred embodiments of this invention, has an optimum particle concentration level (by weight) such that the physical, chemical and mechanical properties of pipe 15 are not compromised. Further, a sinusoidal signature (the unique magnetic pattern), discussed below, of pipe 15 is effectively locatable at typical burial depths (3 feet for main piping and 18 inches for service piping) in both cluttered and uncluttered environments.

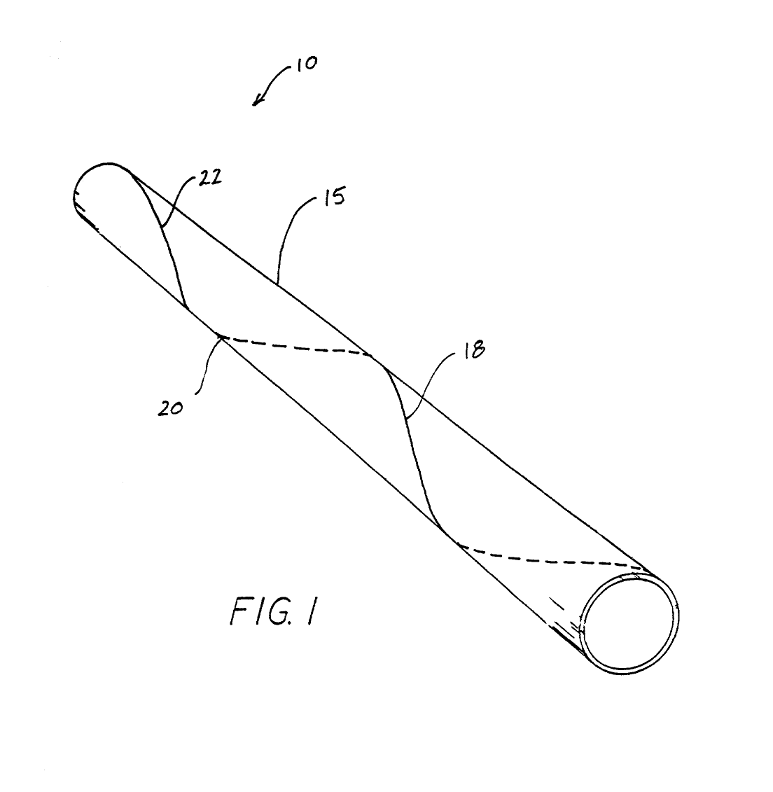

In one preferred embodiment of this invention, intrinsically locatable gas distribution system 10 comprises magnetic polyethylene gas pipe 15 formed of a thermoplastic material. Referring to FIG. 1, preferably, but not necessarily, pipe 15 is formed of a polyethylene resin, for example a conventional medium density grade polyethylene (MDPE) resin and/or a conventional high density grade polyethylene (HDPE) resin. Other suitable materials known to those having ordinary skill in the art may be used to form pipe 15 in accordance with this invention.

Pipe 15 further comprises a plurality of ferrite particles 18 embedded within the thermoplastic material during an extrusion process discussed below, thus giving pipe 15 magnetic properties. In one preferred embodiment of this invention, ferrite particles 18 comprise at least one of strontium ferrite (SrFe) and barium ferrite (BaFe). Other ferrite particle materials, known to those having ordinary skill in the art, having suitable magnetic properties may be used to produce pipe 15. Preferably, but not necessarily, pipe 15 has a ferrite particle concentration by weight of up to about 30%, more preferably about 12% to about 24%, and still more preferably about 17% to about 24%. For example, a strontium ferrite concentration by weight of about 17% is preferred for pipe 15 having a diameter of at least about 2 inches at a typical burial depth of about 36 inches. A strontium ferrite concentration by weight of about 24% is preferred for pipe 15 having a diameter of less than about 2 inches at a typical burial depth of about 18 inches.

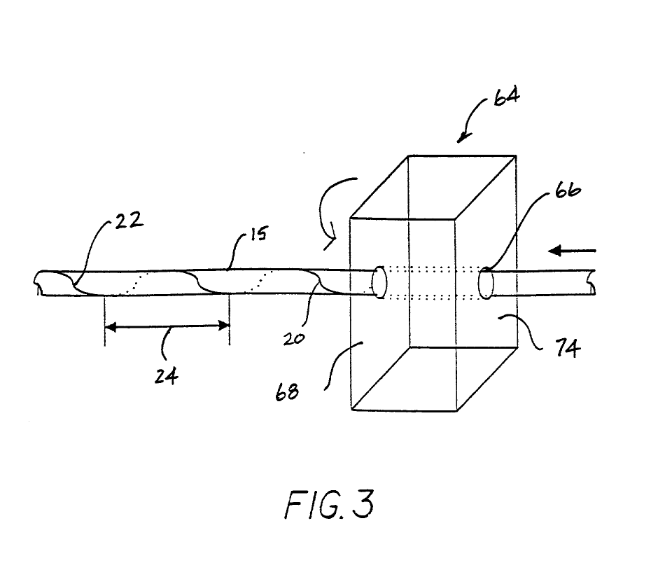

In one preferred embodiment of this invention, embedded ferrite particles 18 are directionally magnetized to produce a distinctive spiral pattern that helps to distinguish pipe 15 from background magnetic objects and/or “clutter.” Preferably, pipe 15 has a magnetic pattern signature 20 having a constant magnitude and a constant change in a direction along a length of pipe 15. Preferably, but not necessarily, magnetic pattern signature 20 has a sinusoidal signature 22 with a constant predetermined periodicity. For example, as shown in FIG. 3, pipe 15 has a sinusoidal signature 22 having a constant period 24 of about 10 feet. At a 10 foot period 24, the sinusoidal signature 22 occurs often enough and at a large enough amplitude to be easily detected. A peak, either high or low, occurs every 5 feet.

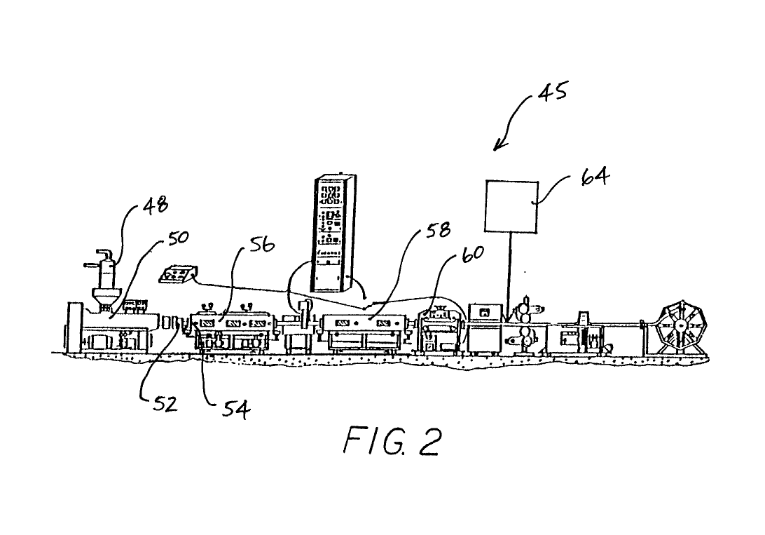

In one preferred embodiment of this invention as shown in FIGS. 2-4, a method of producing locatable PE gas distribution piping material involves intricate and interrelated processes. The governing principles involve an extension and adjustment of a typical PE piping material manufacturing process and magnetization of embedded ferrite particles 18. The raw materials used to manufacture the locatable PE pipe are generally supplied in the form of pellets, powders and/or resins. For example, in one preferred embodiment of this invention, a thermoplastic resin is supplied. Suitable materials known to those having ordinary skill in the art, other than thermoplastic resins, may be used in the production of pipe 15.

During a compounding process, materials, such as a magnetic filler material, color concentrate and carbon black, are added to the thermoplastic resin. In one preferred embodiment of this invention, ferrite particles 18 are added to the thermoplastic resin during the compounding process. An appropriate magnetic filler material must be selected to blend with the polyethylene resin. The magnetic filler material should demonstrate excellent compatibility with the polyethylene resins without adversely affecting the manufacturability of pipe 15; should not adversely impact the production cost of pipe 15; should be environmentally safe and produce a signal sufficient for in-service detectability; and should be commercially available.

In one preferred embodiment of this invention, ferrite particles 18 are added to the thermoplastic resin during the compounding process. For example, a strontium ferrite powder material commercially available from Hoosier Magnetic, under the commercial designation HM406, was used to produce pipe 15 in accordance with one preferred embodiment of this invention. The properties of HM406 are shown in Table 1 below.

TABLE 1
Properties of HM406

| Property | Units | Value |
|---|---|---|
| Chemical Composition | — | SrFe₁₂O₁₉ |
| Theoretical Density | g/cm³ | 5.09 |
| Bulk Density | kg/m³ | 2243 |
| +325 Mesh | wt. % | 5 |
| Average Particle Size | microns (μm) | 3.5 |

The polyethylene resin is homogeneously mixed or compounded with ferrite particles 18 and moved into a hopper 48 positioned above an extruder 50. For example, the HM406 filler material is compounded with the polyethylene resin and carbon black material. As mentioned previously, in one preferred embodiment of this invention, wherein pipe 15 contains about 24% concentration by weight of ferrite particles 18, a 100-part mixture having 76 parts of polyethylene/carbon black must be compounded with 24 parts of HM406 and fed into extruder 50.

Preferably, but not necessarily, extruder 50 is a single screw extruder, which is commonly used for manufacturing PE pipe. It is apparent that other conventional extruders, for example a double-screw extruder, may be used. Extruder 50 heats, melts, and further mixes the compounded material and conveys the molten material through a pipe extrusion die 52. Preferably, the temperature of the melted material is about 390° F. to about 450° F., at a pressure of about 2000 psi to about 4000 psi as the material exists extruder 50.

Pipe 15 is formed by extruding the melted material comprising the thermoplastic resin and ferrite particles 18, wherein the compounded materials are physically formed into pipe 15. During this forming step, ferrite particles 18 are embedded in pipe 15. The molten material exists extruder 50 in the form of two ribbons and then goes to a screen pack, which prevents foreign contaminants from entering the pipe wall and assists in the development of a pressure gradient along the screw of extruder 50 in order to homogenize the material. Pipe extrusion die 52 then distributes the molten material around a solid mandrel, which forms the material into a cylindrical shape for solid wall pipe.

The molten material shaped into solid wall pipe undergoes vacuum sizing whereby the extrudate is drawn through a sizing tube or sleeve 54 while the surface of pipe 15 is cooled enough to maintain proper dimensions and its circular form. In accordance with embodiments of this invention, various cooling methods may be utilized. Depending on the diameter of pipe 15, either total immersion or spray cooling may be used. For small diameter pipe, total immersion is preferable. Total immersion involves immersing pipe 15 in a cold temperature water bath within a cooling tank 58, as shown in FIG. 2, at a temperature of about 40° F. to about 50° F. Pipe 15 is then pulled through the cooling bath by a puller 60. The rate at which puller 60 pulls pipe 15 through cooling tank 58, in conjunction with the screw speed, determines a thickness of a pipe wall. For example, reducing the pull rate at a constant screw speed increases the thickness of the pipe wall. Conversely, increasing the pull rate at constant screw speed decreases the thickness of the pipe wall.

Pipe 15 is then marked in ink at frequent intervals per ASTM D2513 specifications with the use of an offset roller. Generally, the markings include the nominal pipe size, type of plastic, SDR, manufacturer's name and code.

During the post-extrusion cooling process, ferrite particles 18 are directionally magnetized using a magnetizer 64 which superimposes a magnetic field upon pipe 15. Magnetizer 64 is preferably a portable, self-contained unit that is independent of production setup 45. In one preferred embodiment of this invention, ferrite particles 18 are directionally magnetized by an in-line post-extrusion magnetization unit or magnetizer 64 to produce magnetic pattern signature 20. Preferably, magnetic pattern signature 20 has a constant magnitude and a constant change in a direction along the length of pipe 15. As shown in FIG. 3, magnetizer 64 accurately centers pipe 15 within a bore 66 formed in magnetizer 64 and ensures that period 24 of magnetic pattern signature 20 repeats at a predetermined interval.

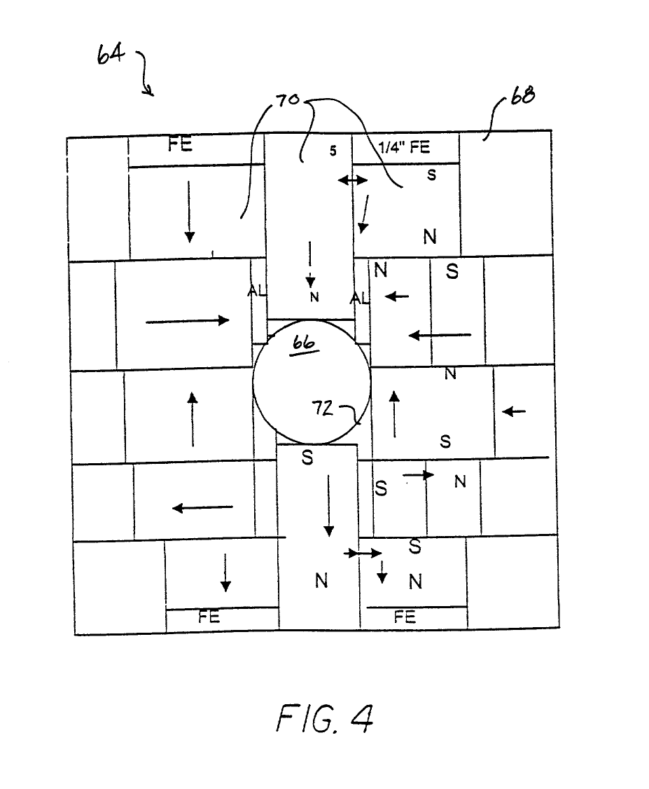

Referring to FIGS. 3 and 4, since a unique sinusoidal signature must be superimposed on pipe 15, a chassis 68 containing a plurality of magnets 70 must rotate slowly as extruded pipe 15 passes through chassis 68. Preferably, magnets 70 are permanent magnets. Further, a cam rotation mechanism 72 positioned within magnetizer 64 is directly related to a linear extrusion rate or line speed (in./min.) in order to achieve the constant predetermined periodicity of magnetic pattern signature 20 along at least a surface or a periphery of pipe 15, as represented by the following equation:

ω=line speed×[1 ft./12 in.]×[1 rev./10 ft.]; Eq. (1)

wherein w is the rotational speed of magnetizer chassis 68 (rev./min.). As a result, for a predetermined periodicity of 10 feet, the calculated rotational speed of a magnetized core 74 for a given line speed is shown in Table 2 below.

TABLE 2
Rotational Speed of Magnetizer Core For Given Line Speed

| | | Magnetized Core |
|---|---|---|
| | Line Speed | Rotational Speed |
| Pipe size | (in./min.) | (rev./min.) |
| ½-inch CTS | 600 | 5 |
| 4-inch IPS | 40 | 0.33 |

Magnetizer 64 can be designed to accommodate pipes 15 having different outer diameters. For example, a magnetizer 64 may be designed to accommodate pipe 15 having an outer diameter less than about 2 inches. Similarly, magnetizer 64 may be designed to accommodate pipe 15 having an outer diameter at least about 2 inches, for example about 2 inches to about 4 inches. The primary difference in accommodating pipes 15 having different outer diameters is the size of chassis 68 and the strength of magnets 70.

Given the unique spirally magnetic signature that is superimposed on at least the surface of pipe 15, magnetizer 64 must rotate slowly as extruded pipe 15 passes through magnetizer 64. To maintain a constant period, measured from peak to peak on sinusoidal signature 22 as shown in FIG. 2, the rotation of core 74 is directly related to the linear extrusion rate or line speed. Further, by using ferrite particles 18 as the embedding substance, a significantly larger magnetic field is required. Preferably, a magnetic field of at least about 6 kiloGauss (KG) is produced. Thus, magnets large and powerful enough to magnetize 2 inch SDR11 pipe at 6 KG are required. In order to obtain the desired magnetic field strength, the use of niodynium-iron-boron magnets is preferred.

In one preferred embodiment of this invention, magnetizer 64 is a modified Halbach dipole magnetizer having rectangular magnets 70, rather than more costly prism-shaped magnets. FIG. 4 shows the magnet array design. The arrows in FIG. 4 indicate the direction of magnetization and the “AL” designates aluminum blocks. The respective magnets 70 are positioned, for example epoxied in place, and installed in chassis 68 of magnetizer 64 in order to utilize cam rotation mechanism 72. The varying magnetic direction shown in the respective array in FIG. 4 leads to a tremendous force of attraction between individual magnets 70. As a result, a great deal of care must be used in handling magnets 70. Damage to core 40 can cause a great deal of harm to equipment and personnel. Magnetizer 64 having permanent magnets 70 can be utilized in a continuous operation over several days in the production of over 8000 feet of magnetic PE pipe 15, without any problems. Using a Hall magnetic field probe, the magnetic field at all points around the circumference of bore 66 was measured. The results indicate that the magnetic field at each point exceeds 6 KG, which is sufficient to magnetize ferrite particles 18.

A commercial capacity magnetizer unit can accommodate typical production extrusion settings. Two separate production scale magnetizers 30 have been developed for various size pipe diameters, an AILM 2.375 unit for pipe diameters less than about 2-inch IPS, and an AILM 4.0 for pipe diameters of about 2-inch IPS and above. The development of two individual units ensures safety and production criteria. As mentioned previously, if core 40 is not handled properly, the varying directions in the orientation of magnets 70 can potentially harm both equipment and personnel. Further, a single unit limits the production of different pipe diameters and introduces uncertainty in the ability for the magnetic flux to penetrate the smaller diameters when using a magnetizer having a larger bore size, e.g. the bore size for use in magnetizing a 4-inch pipe being used to magnetize ½″ CTS tubing.

The production scale magnetizer 64 must have means for adjusting a centerline height, which is critical in the production of plastic piping. Further, the rotation of core 40 of production scale magnetizer 64 must be able to accommodate production scale extrusion line speeds. The periodicity that is introduced to magnetize the pipe in a spiral fashion is directly related to the extrusion line speeds, and must incorporate a factor of safety. Typical extrusion rates for ½″ CTS tubing is approximately 600 in./min. and for 4-inch IPS pipe is approximately 40 in./min. Thus, the rotational speed of core 40 is approximately 5 rpm and 0.33 rpm for the ½″ CTS tubing and 4-inch IPS pipe, respectively. Finally, production scale magnetizer 64 must incorporate standard safety and maintenance features associated with typical commercial grade equipment.

In one preferred embodiment of this invention, the optimum ferrite concentration by weight was determined such that pipe 15 would be locatable at typical burial depths without adversely affecting the long-term strength, durability and properties of pipe 15. Through a hybrid approach of field experimentation and computational modeling, the optimum ferrite concentration was determined.

Several field experiments were performed using magnetic pipes having various filler material particle concentration levels containing up to 7% concentration by weight filler material particles. Several filler materials were tested, including strontium ferrite, barium ferrite, and iron oxides, for compatibility with medium density grade polyethylene resins and high density grade polyethylene resins. Based on the results of these studies, pipe 15 produced with strontium ferrite materials exhibited better detectability and long-term strength. However, in order to clearly distinguish its magnetic signal from existing buried objects, the filler material particle concentration may be increased.

A series of computational models have been developed to determine the optimum ferrite concentration levels. A number of variables were taken into account, including: pipe size, pipe burial depth, filler material particle concentration, position of the locator, and magnetization mode. The goal was to incorporate the independent contributions of the various factors into a single equation for the vertical component of the magnetic field that could be sensed above ground. The computational model was validated through the use of empirical data obtained from pipes containing 12% and 17% ferrite particle concentration levels. The model was then extended to reflect the effects of spiral magnetization. On the basis of the computational model and experimental validation, it was concluded that the optimum ferrite concentration levels for main and service size piping are 17% and 24%, respectively. An additional conclusion of the modeling work demonstrates that for a given burial depth, as the pipe size increases, the corresponding percent particle concentration decreases to produce the same level of signal intensity. Details pertaining to the computational model and the inherent assumptions can be found in a paper entitled “The Development and Validation of Locatable PE Gas Distribution Piping Systems,” published in Proceedings 1997 International Gas Symposium—Plastic Piping Systems for Gas Distribution.

Once buried, conventional and/or advanced locating technologies are employed to locate gas distribution system 10 and distinguish gas distribution system 10 from existing buried objects, including, but not limited to, steel objects and cast iron objects.

Preferably, but not necessarily, a 3-axis locator is used with the gas distribution system 10 according to this invention to clearly distinguish the unique spiraling magnetic pattern signature 20 superimposed on pipe 15. The 3-axis locator is enhanced to include 3-axis sensing capabilities and comprises a three-orthogonal (perpendicular to one another) sensor enabled to measure a magnitude and a direction of a magnetic field. Thus, allowing for the detection of a unique spiral magnetization. The 3-axis locator is beneficial to the detection of pipe 15. The 3-axis locator enhances the output of the spiral magnetization due to its constant magnitude with a change of direction in the X, Y and/or Z-axis along the length of pipe 15.

In one preferred embodiment of this invention, the 3-axis locator comprises a visual LCD display and a data storage unit that gathers the magnetic signal information along the length of pipe 15. The 3-axis locator can distinguish the spiral magnetization through the LCD display board, showing the varying magnitudes of magnetization of pipe 15 in each direction (X, Y and Z). In the spiral magnetization pattern, each axis will never be at a maximum at that same point in time. Conversely, for steel and cast iron pipe, there is only one constant magnitude along the length of the pipe. Therefore, a 3-axis locator can distinguish between the different types of pipe. Conversely, a conventional 1-axis locator will not have the capabilities of distinguishing between pipe 15 and steel and/or cast iron because the 1-axis locator will only show one peak magnitude.

The 3-axis locator has four different modes that the user can chose from: the Setup mode; the Magnitude and Bar Graph mode; the Dial Chart mode; and the Depth Display mode. Each of these modes allows the user to accurately locate pipe 15.

In the set-up mode, the user has three options: (1) zero out the instrument, (2) enter in the size of the pipe, and (3) change the sensitivity of the instrument. The instrument should be zeroed-out in a non-cluttered area so that the instrument will account for the earth's magnetic field. The size of the pipe must be entered to obtain an accurate reading of the depth. The depth is related to the magnitude of the reading and the size of the pipe. In areas where the pipe is buried deep, the sensitivity can be increased to help the user locate the pipe.

The magnitude and bar graph mode is the resultant of the three axial components. The resultant represents the square root of the sum of the squares of each axial component. When the user is over the pipe, the magnitude reading on the display will be at a maximum. As the user swings the instrument left and right, that magnitude will decrease the further away it is from the pipe. This display is the best option for locating the material in the field.

There is a second mode that shows a separate bar graph for each of the components. This mode allows the user to see the different magnitude along each individual axial component (X, Y, Z). This mode is essential in cluttered environments. The difference between locating magnetic PE pipe 15 and steel is that for steel all three axial components will be at a maximum. Magnetic PE pipe 15 will never have all three components at a maximum due to sinusoidal signature pattern 22.

The dial chart mode is most effective after the user has found the pipe TV using the magnitude and bar graph mode. This mode will spin in a circular motion, representing the sinusoidal signature pattern 22 of pipe 15, as the user walks along the length of pipe 15.

In the depth display mode, to take a depth reading when the user is on pipe 15, the instrument is placed on the ground and the depth display button is pushed. The depth of pipe 15 is determined from the magnitude and the size of pipe 15. To ensure accuracy of the depth reading, the pipe size must be entered in correctly in the setup mode. If the user is not directly over pipe 15, the depth reading will represent the resultant of the distance between pipe 15 and the user.

It is recognized that the most common modes of failure for conventional plastic gas distribution pipes are short-term “ductile” rupture and long-term “slow crack growth.” The use of thermoplastic pipe materials for gas distribution is governed by ASTM D2513 entitled “Standard Specification for Thermoplastic Gas Pressure Pipe, Tubing, and Fittings.” Provided that magnetic PE pipe 15 meets the cell classifications associated with its base polyethylene resin, all requirements contained in D2513 and its annexes are readily transferable to magnetic PE pipe 15. The following tests and examples cover minimum requirements and test methods used to obtain physical, mechanical and chemical properties of pipe materials suitable for use in gas distribution system 10. The results of the tests help to characterize the structural integrity of pipe 15 in terms of its ability to withstand the stresses caused by internal gas pressure and to prevent leakage through the pipe walls and joints.

Consequently, testing was performed to characterize the integrity and long term durability of magnetic PE pipe 15 at ferrite particle concentration levels up to 24% by weight in both medium density grade polyethylene resins and high density grade polyethylene resins. The results of the testing indicate that the introduction of ferrite particles 18 into the polyethylene resins at concentration levels up to 24% by weight do not adversely affect the physical, mechanical and/or chemical properties of magnetic PE pipe 15.

### TEST METHODS AND EXAMPLES

Comprehensive testing was carried out on three lots of magnetic PE pipe 15 produced using both medium density and high density grades of polyethylene resins utilized by Plexco at both 17% and 24% ferrite particle concentration levels.

### Hydrostatic “Quick Burst” Test

The hydrostatic quick burst test per ASTM D1599-88 is a relatively easy-to-perform test that brings about laboratory failures in a short period of time. This particular test method includes determining the hydraulic pressure necessary to produce a failure within 60 to 70 seconds. This test is geared towards laboratory testing requirements as well as for in-coming quality inspections at a particular LDC. Data generated as a result of this testing is useful for predicting the behavior of the pipe under similar temperatures, time, loading, and hoop stress as the actual test. This test is not indicative of the long-term strength or durability of the resin or the pipe.

Specimens from each lot were measured and conditioned at 73° F. for at least 16 hours and then filled with water and submerged in a water bath at 73 ° F. The pressure was then increased uniformly until each of the specimens failed. Based on these pressures, the hoop stress at failure for each specimen is calculated as follows:

S =[p x (D−t)]/2t; Eq. (2)

wherein S=hoop stress (psi),

p=internal pressure (psi),

D=average outer diameter (in.), and

t=minimum wall thickness (in.).

The results of this testing are presented in Table 3. From the results, there is no variation in the quick burst values of magnetic PE pipe 15 specimens as compared to the base PE resin in both medium density and high density. The test results for magnetic PE pipe 15 exceeds the requirements per ASTM D2513.

TABLE 3
Minimum Hydrostatic Quick Burst Measurements
for Magnetic PE Pipe

| | | | |
|---|---|---|---|
| Lot | Average Failure | Hoop Stress | Failure |
| Number | Pressure (psi) | (psi) | Mode |

17% Medium Density

| | | | |
|---|---|---|---|
| 1 | 621 | 2890 | Ductile |
| 2 | 600 | 2875 | Ductile |
| 3 | 590 | 2833 | Ductile |

24% Medium Density

| | | | |
|---|---|---|---|
| 1 | 635 | 3082 | Ductile |
| 2 | 631 | 3034 | Ductile |
| 3 | 635 | 3020 | Ductile |

17% High Density

| | | | |
|---|---|---|---|
| 1 | 726 | 3559 | Semi-Ductile |
| 2 | 748 | 3656 | Semi-Ductile |
| 3 | 742 | 3603 | Semi-Ductile |

24% High Density

| | | | |
|---|---|---|---|
| 1 | 744 | 3688 | Semi-Ductile |
| 2 | 707 | 3548 | Semi-Ductile |
| 3 | 709 | 3535 | Semi-Ductile |

### Apparent Tensile Strength Test

The apparent tensile strength was measured in accordance with ASTM D2290 entitled “Standard Test Method for Apparent Tensile Strength of Ring or Tubular Plastics and Reinforced Plastics by Split Disk Method.” This test provides an excellent degree of correlation with the minimum hydrostatic quick burst measurements. Split disk specimens are prepared under controlled conditions and subjected to tensile loading at a specified rate. Specimens from each of the three lots of magnetic PE pipe 15 for both concentration levels were conditioned at 73° F. and 50% relative humidity for 24 hours prior to testing. The specimens were prepared to conform to D2290 specifications for specimen thickness (0.50 in.) and reduced notch thickness (0.250 in.). The specimens were placed within the test fixtures and pulled at a rate of 0.5 in./min.

The results of the testing are summarized in Table 4 below. These results demonstrate a good degree of correlation between the apparent tensile strength values and the quick burst values for magnetic PE pipe 15.

TABLE 4
Apparent Tensile Strength Measurements for Magnetic PE Pipe

| | | |
|---|---|---|
| Lot | Tensile Strength | Tensile Strength |
| Number | at Yield (psi) | at Break (psi) |

17% Medium Density

| | | |
|---|---|---|
| 1 | 3010 | 3015 |
| 2 | 2922 | 2932 |
| 3 | 2986 | 3000 |

24% Medium Density

| | | |
|---|---|---|
| 1 | 3208 | 3213 |
| 2 | 3295 | 3303 |
| 3 | 3252 | 3257 |

17% High Density

| | | |
|---|---|---|
| 1 | 3833 | 3837 |
| 2 | 3845 | 3850 |
| 3 | 3754 | 3760 |

24% High Density

| | | |
|---|---|---|
| 1 | 3742 | 3747 |
| 2 | 3422 | 3426 |
| 3 | 3538 | 3542 |

### Chemical Resistance Test

To determine the effectiveness of polyethylene plastics to withstand certain types of short-term exposure to chemical degradation, ASTM D2513 specifications requires that split disk specimens fabricated to D2290 specifications must be tested in accordance with D543 specifications entitled “Standard Test Method for Resistance of Plastics to Chemical Reagents.”

Split disk specimens from each lot of material of magnetic PE pipe 15 (both medium density and high density) at both ferrite particle concentration levels ha were prepared in accordance with D2290 specifications (see Apparent Tensile Strength Test). Measurements were taken to determine the initial weight of the specimens, the dimensions for the specimen thickness and reduced wall section. The specimens were completely immersed in the specified chemical reagents: 100% mineral oil, 100% ethylene glycol, 100% methanol, and 15% toluene in methanol for a 72 hour time period. Upon removal, each specimen was carefully wiped clean of excess chemical and allowed to air dry for approximately 2 hours prior to re-weighing. Both the initial and final weights were recorded. A tensile load was applied at a rate of 0.5 in./min. to quantify the tensile strength at yield.

ASTM D2513 specifications require that the pipe materials shall not increase in weight by more than 0.5% (1.0% for toluene in methanol), and that the apparent tensile strength at yield shall not change more than ±12% for any of the specified chemicals.

Average values for the percent change in weight and tensile strength for each concentration level (average of the three lots) in both medium density and high density magnetic PE pipe 15 are presented in Table 5. The results indicate that magnetic PE pipe 15 specimens meet or exceed the ASTM D2513 requirements.

TABLE 5
Results of Chemical Resistance Measurements for Magnetic PE Pipe

| | | | |
|---|---|---|---|
| | Tensile | | Change in |
| | Strength at | Change in | Tensile Strength |
| Reagent | Yield (psi) | Weight (%) | at Yield (%) |

17% Medium Density

| | | | |
|---|---|---|---|
| Mineral Oil | 2,969 | 0.104 | 1.25 |
| Methanol | 2,999 | 0.026 | 0.89 |
| Ethylene Glycol | 3,010 | 0.059 | 1.25 |
| Toluene in Methanol | 2,889 | 0.448 | 2.83 |

24% Medium Density

| | | | |
|---|---|---|---|
| Mineral Oil | 3,248 | 0.159 | 0.60 |
| Methanol | 3,198 | 0.090 | 1.64 |
| Ethylene Glycol | 3,234 | 0.124 | 0.55 |
| Toluene in Methanol | 3,139 | 0.487 | 3.50 |

17% High Density

| | | | |
|---|---|---|---|
| Mineral Oil | 3,808 | 0.231 | 0.67 |
| Methanol | 3,738 | 0.038 | 1.91 |
| Ethylene Glycol | 3,762 | 0.148 | 1.29 |
| Toluene in Methanol | 3,670 | 0.228 | 3.70 |

24% High Density

| | | | |
|---|---|---|---|
| Mineral Oil | 3,568 | 0.241 | 0.18 |
| Methanol | 3,484 | 0.046 | 2.32 |
| Ethylene Glycol | 3,543 | 0.045 | 1.23 |
| Toluene in Methanol | 3,488 | 0.363 | 2.24 |

### Ultra-Violet Degradation Resistance Test

In order to determine the effectiveness of magnetic PE pipe 15 to withstand the effects of ultraviolet radiation, a modified testing protocol based on ASTM D2290 and D543 was utilized. ASTM D2513 requires that pipe intended for gas use must be capable of being stored outside and unprotected for a minimum of two years. If the pipe is stored for a period of more than two years, the pipe must be tested to ensure that it still meets all of the specifications required within the standard.

For this test, Q-Panel UNA-340 fluorescent lamps were used. These bulbs emit ultraviolet radiation between 295 nm and 365 nm with peak emission at 340 nm. The QUV equipment uses fluorescent bulbs, which emit ultraviolet wavelengths in prescribed patterns.

In order to ensure that the material properties of magnetic PE pipe 15 are not adversely affected by exposure to UV radiation, accelerated aging tests were performed. Six specimens from each lot of pipe material for both medium density and high density were fabricated to dimensions specified for ASTM D2290 split ring specimens. These specimens were then exposed to 1000 hours of constant ultraviolet light using Q-panel exposure equipment.

After 1000 hours of exposure, a constant tensile load was applied on the exposed specimens at a rate of 0.5 in./min., and the apparent tensile strength at yield was calculated for each specimen from each lot. The values were then compared to control specimens from the previous apparent tensile strength test. The results of the test are summarized in Table 6 below.

TABLE 6
Results of UV Degradation Resistance
Measurements for Magnetic PE Pipe

| | | |
|---|---|---|
| Lot | Tensile Strength | Tensile Strength |
| Number | at Yield (psi) | at Break (psi) |

17% Medium Density

| | | |
|---|---|---|
| 1 | 3,280 | 3,290 |
| 2 | 3,035 | 3,040 |
| 3 | 3,088 | 3,095 |

24% Medium Density

| | | |
|---|---|---|
| 1 | 3,354 | 3,358 |
| 2 | 3,354 | 3,361 |
| 3 | 3,402 | 3,406 |

17% High Density

| | | |
|---|---|---|
| 1 | 3,800 | 3,802 |
| 2 | 3,793 | 3,797 |
| 3 | 3,792 | 3,796 |

24% High Density

| | | |
|---|---|---|
| 1 | 3,811 | 3,814 |
| 2 | 3,555 | 3,560 |
| 3 | 3,620 | 3,622 |

The above test results indicate no decrease in the yield strength and the tensile strength of the split ring samples after an 1000 hour UV exposure. Thus, magnetic PE pipe 15 has the capability to be stored outside and unprotected for a period of two years.

### Melt Flow Index Test

Melt flow index is the flow rate of PE materials when tested per ASTM D1238 Procedure B entitled “Standard Test Method for Flow Rates of Thermoplastics by Extrusion Plastomer.” This method gives a measure of the rate of extrusion of molten resins through a die of a specified length and diameter under prescribed conditions of temperature, load on the piston, and time.

Small samples of magnetic PE pipe 15 in both pipe and blended resin form were placed in a heated chamber in a small extruder. The samples were extruded through a calibrated die under a prescribed load of 2.16 kg for a period of 6 minutes. The extruded portions were weighed and compared against the prescribed conditions. This served to indicate the flow rate of the polymer against the specified melt index. This is a standard test among LDC's as part of their incoming quality inspection program.

The resulting averages for all lots of magnetic PE pipe 15 at both concentration levels and grades show excellent agreement in the melt index between the pipe and resin. Table 7 below shows the results of the test.

TABLE 7
Results of Melt Index Measurements for Magnetic PE Pipe

| Specimen Type | Melt Index (g/10) |
|---|---|
| 17% Medium Density—Pipe | 0.1806 |
| 17% Medium Density—Resin | 0.1960 |
| 24% Medium Density—Pipe | 0.2752 |
| 24% Medium Density—Resin | 0.3107 |
| 17% High Density—Pipe | 0.1877 |
| 17% High Density—Resin | 0.1697 |
| 24% High Density—Pipe | 0.2062 |
| 24% High Density—Resin | 0.1773 |

### Density

The density of PE materials is tested in accordance with ASTM D792 entitled “Standard Test Methods for Density and Specific Gravity (Relative Density) of Plastics by Displacement.” The density measurements on magnetic PE pipe 15 up to 24% concentration levels resulted in values greater than 1.0. Table 8 below shows the results of the test.

TABLE 8
Results of Density Measurements for Magnetic PE Pipe

| Specimen Type | Density (g/cm³) |
|---|---|
| 17% Medium Density—Pipe | 1.1089 |
| 17% Medium Density—Resin | 1.1092 |
| 24% Medium Density—Pipe | 1.1838 |
| 24% Medium Density—Resin | 1.1682 |
| 17% High Density—Pipe | 1.1329 |
| 17% High Density—Resin | 1.0908 |
| 24% High Density—Pipe | 1.1780 |
| 24% High Density—Resin | 1.2154 |

The difference in density between the PE resin and the ferrite particles implies that the overall weight for magnetic PE pipe 15 will be greater than conventional PE pipe with equivalent dimensions.

### Flexural Modulus Test

One useful means of quantifying the tensile properties is the determination of the flexural modulus of magnetic PE pipe 15. Specimens from all lots of pipe in both concentration levels in medium density and high density grades were tested in accordance with ASTM D790 entitled “Standard Test Method for Flexural Properties of Unreinforced and Reinforced Plastics and Electrical Insulating Materials.”

Standard flexural specimens were molded from magnetic PE pipe 15 samples of each lot (both medium density and high density). Width and depth of each specimen was measured prior to testing. Method I was used for all tests. This is a three point loading system utilizing center loading on a simply supported beam. The sample is placed in a test jig and centered between the fixed supports. The moving support travels down into the specimen at a fixed rate of 0.1 inches per minute. The flexural modulus is defined as the slope of the steepest linear portion of the load deflection curve. The data for each of the respective lots of pipe is summarized in Table 9 below.

TABLE 9
Results of Flexural Modulus for Magnetic PE Pipe

| Specimen Type | Flexural Modulus (ksi) |
|---|---|
| 17% Medium Density | 150 |
| 24% Medium Density | 162 |
| 17% High Density | 196 |
| 24% High Density | 202 |

The flexural modulus of magnetic PE pipe 15 falls into the cell classification of 5 and 6 for medium density and high density, respectively. The to flexural strength is related to the density and the molecular weight. As the density increases, the material becomes stiffer since the molecules have less space for resistance movement. The density of magnetic PE pipe 15 is greater than the conventional polyethylene pipe due to the addition of ferrite particles 18. This increase in density results in an increase in flexural modulus. This cell classification is higher than the standard polyethylene resins. Although magnetic PE pipe 15 is a stiffer material than polyethylene, it still has the capability of being coiled.

### Tensile Strength Test

In addition to the apparent tensile strength test, tensile properties for magnetic PE pipe 15 were obtained utilizing ASTM D638 entitled “Tensile Properties of Plastics.” This test method determines the tensile properties of plastics by performing a constant load test on specimens under controlled conditions of temperature, humidity, preparation, and rate of the testing machine.

Six specimens from each lot of magnetic PE pipe 15 (both medium density and high density) were die-cut into Type IV specimens. Each specimen was conditioned at 73° F. and 50% humidity for 48 hours prior to testing. Measurements were recorded for width and thickness of each specimen. The rate of the machine was set at 2 inches per minute, and the tensile strength at yield and break was recorded. The results of the test are summarized in Table 10 below.

TABLE 10
Results of Tensile Strength Measurements for Magnetic PE Pipe

| | | |
|---|---|---|
| Lot | Tensile Strength | Tensile Strength |
| Number | at Yield (psi) | at Break (psi) |

17% Medium Density

| | | |
|---|---|---|
| 1 | 2,775 | 4,100 |
| 2 | 2,700 | 4,200 |
| 3 | 2,789 | 4,340 |

24% Medium Density

| | | |
|---|---|---|
| 1 | 2,838 | 3,747 |
| 2 | 3,166 | 4,245 |
| 3 | 3,037 | 4,237 |

17% High Density

| | | |
|---|---|---|
| 1 | 3,853 | 4,876 |
| 2 | 3,800 | 4,517 |
| 3 | 3,966 | 4,207 |

24% High Density

| | | |
|---|---|---|
| 1 | 3,686 | 3,718 |
| 2 | 3,893 | 4,075 |
| 3 | 3,856 | 4,018 |

The tensile strength of magnetic PE pipe 15 is equivalent to the standard polyethylene resins for both medium density and high density pipe. The above results show that the addition of ferrite particles 18 have no adverse effect on the strength of the material.

### Magnetic PE Pipe Cell Classification

The cumulative results of the testing help characterize the resistance to short-term “ductile” rupture and the physical properties of magnetic PE pipe 15. Most importantly, the test results help to classify magnetic PE pipe 15 into a particular cell classification.

Per ASTM D2513 Annex Al requirements, polyethylene materials for use in the manufacture of pipe and fittings shall be classified per ASTM D3350 specifications, which take into account short term physical properties and long term durability.

Table 11 summarizes the primary physical properties for the respective cell classification limits per D3350 requirements. The following requirements are an abbreviated version of ASTM D3350 to demonstrate the correlation between magnetic PE pipe 15 and conventional PE pipe.

TABLE 11
Primary Properties - Cell Classification Limits
per D3350 Requirements

| | Test | | | | | | |
|---|---|---|---|---|---|---|---|
| Property | Method | 1 | 2 | 3 | 4 | 5 | 6 |
| Density | D1505 | 0.910 | 0.926 | 0.941 | >0.955 | — | — |
| (g/cm³) | | to | to | to | | | |
| | | 0.925 | 0.940 | 0.955 | | | |
| Melt Index | D1238 | >1.0 | 1.0 to 0.4 | <0.4 to | <0.15 | | |
| (g/10) | | | | 0.15 | | | |
| Flexural | D790 | <138 | 138 to | 276 to | 552 to | 758 to | >1108 |
| Modulus, | | (<20) | 276 | <552 | <758 | <1108 | (>160) |
| MPa (ksi) | | | (<40) | (40 to 80) | (80 to | (110 to | |
| | | | | | <110) | <160) | |
| Tensile | D638 | <15 | 15 to <18 | 18 to <21 | 21 to <24 | 24 to | >28 |
| Strength at | | (<2.2) | (2.2 to | (2.8K to | (3.0 to | <28 (3.5 | (>4.0) |
| Yield, | | | <2.8) | <3.0) | <3.5) | to <4.0) | |
| MPa (ksi) | | | | | | | |
| PENT (hrs) | F1473 | 0.1 | 1 | 3 | 10 | 30 | 100 |
| Hydrostatic | D2837 | 5.52 | 6.89 | 8.62 | 11.03 | — | — |
| Design Basis | | (800) | (1000) | (1250) | (1600) | | |

Table 12 illustrates the current cell classifications for polyethylene pipe and fittings for medium density (PE2406) and high density (PE3408) found in ASTM D2513-99.

TABLE 12
Cell Classification of Polyethylene Pipe and Fittings per D2513

| PE Material | Cell Classification | Cell Classification |
|---|---|---|
| Designation Property | PE2406 | PE3408 |
| Density | 2 | 3 |
| Melt Index | 1, 2 or 3 | 3, 4 or 5 |
| Flexural Modulus | 3 or 4 | 4 or 5 |
| Tensile Strength | 3 or 4 | 4 or 5 |
| PENT | 6 | 6 |
| Hydrostatic Design Basis | 3 | 4 |

The addition of ferrite particles 18 up to 24% concentration levels does not adversely affect the cell classification for magnetic PE pipe 15. Comparison of the various properties obtained from testing and evaluation of magnetic PE pipe 15 with the cell classification limits found in D3350 indicates that the cell class for medium density and high density magnetic PE pipe 15 correlate with conventional grades of PE resins. Table 13 demonstrates the cell classification limits of medium density and high density magnetic PE pipe 15 up to 24% concentration levels (values are averages from all lots of testing).

TABLE 13
Cell Classification of Magnetic PE Pipe per D2513

| | | | Medium | High |
|---|---|---|---|---|
| | | | Density | Density |
| | Medium | High | Magnetic | Magnetic |
| | Density | Density | Pipe | Pipe |
| Material | Magnetic | Magnetic | (up to 24%) | (up to 24%) |
| Designation | Pipe | Pipe | Classifica- | Classifica- |
| Property | (up to 24%) | (up to 24%) | tion | tion |
| Density | >1.0 | >1.0 | 4 | 4 |
| Melt Index | 0.3 | 0.2 | 3 | 3 |
| Flexural | 156 ksi | 199 ksi | 5 | 6 |
| Modulus | | | | |
| Tensile | 2875 psi | 3850 psi | 3 | 5 |
| Strength | | | | |
| PENT | >100 hours | >100 hours | 6 | 6 |
| Hydrostatic | 1250 psi | 1600 psi | 3 | 4 |
| Design Basis | | | | |

It is important to note that the reported density is the blended magnetic PE pipe resin, which takes into account the increased density of the ferrite particles. However, the density used for that cell classification is that of the PE base resin per D3350 requirements.

With plastics, the long term strength and durability can vary significantly with the time of loading, temperature, and environment. Plastics are very complex combinations of elastic and fluid like elements and they exhibit properties shared between those of a crystalline metal and a viscous fluid, viscoelasticity.

Because of this viscoelastic behavior, conventional hydrostatic quick burst and short-term tensile tests, as discussed above, cannot be used to predict long-term performance of plastics under loading. When a plastic is subjected to a suddenly applied load that is then held constant, it deforms immediately to a strain predicted by the stress-strain modulus. It then continues to deform at a slower rate for an indefinite period. If the stress is large enough, then the rupture of the specimen eventually will occur. This time dependent viscous flow component of deformation is known as creep, and the failure that terminates it is known as creep rupture.

As the stress levels decrease, the time to failure increases and material deformation becomes smaller. At very long times to failure, deformation is usually less than 5% for most thermoplastics. The fracture is then a result of crack initiation and slow crack growth. A large body of previous research sponsored by Gas Research Institute indicates that this type of “brittle” failure, not the excessive deformation, is the ultimate limit of the long-term performance of plastic pipe in service. Failures in the ductile mode also may occur, but only in operating conditions where the pressure in service is accidentally increased.

As a result, there is an overwhelming need to conduct long-term testing to identify the longevity of the material when it fails in the brittle mode. Long term hydrostatic sustained pressure testing has been accepted by the industry for a long period of time. More recently, however, other tests have been conducted to predict the lifetime of the material. In addition to the PENT test developed for Gas Research Institute at the University of Pennsylvania for the characterization of slow crack growth resistance, the other test includes the 120° three-point bend sector test developed at Battelle and modified in subsequent work by Southwest Research Institute and Ohio State University.

In order to develop an accurate means of forecasting the long-term strength of thermoplastic pipe material, ASTM D2837 “Standard Method for Obtaining the Hydrostatic Design Basis (“HDB”)for Thermoplastic Pipe Materials” has been adopted by the industry.

The procedure involves obtaining empirical data for the hoop stress versus time to failure from 10 to 10,000 hours. Pipe specimens are subjected to sustained pressure tests per ASTM D1598 “Time-to-Failure of Plastic Pipe under Constant Internal Pressure.” The data is plotted on a log-log scale with hoop stress plotted as the ordinate and time to failure as the abscissa. Using the method of least squares, a best fit straight-line is drawn through these points. The curve fit is then extrapolated mathematically to the 100,000 hour intercept called the long-term hydrostatic strength (LTHS). Depending on the range of the LTHS, a specified value for the HDB is assigned. Per Annex Al and D2837 requirements, the HDB is substantiated when the extrapolation of the stress regression curve is linear to the 438,000 hour (long-term hydrostatic strength at 50 years).

Long term sustained pressure testing to characterize the HDB of magnetic PE pipe has been performed on both medium density and high density magnetic pipe containing up to 24% concentration of ferrite particles. The testing has progressed through the experimental grade listing (E2 listing) per PPI requirements and is still ongoing until the standard grade listing has been obtained. To date, medium density magnetic PE pipe with up to 24% concentration loading has an approved PPI listing of 1250 psi, which is consistent with conventional MDPE materials. In addition, high density magnetic PE pipe with up to 24% concentration loading has an HDB listing of 1600 psi, which is consistent with conventional HDPE materials.

While in the foregoing specification this invention has been described in relation to certain preferred embodiments thereof, and many details have been set forth for purpose of illustration, it is to be understood, as aforementioned, that this invention is susceptible to additional embodiments and that certain of the details described herein can be varied considerably without departing from the basic principles of the invention expressed herein.

I claim:

1. A locatable gas distribution system comprising:
a pipe formed of a thermoplastic material; and
a plurality of ferrite particles within the thermoplastic material,
wherein the pipe having a magnetic pattern signature, the magnetic pattern signature having a constant magnitude and a constant change in a direction along a length of the pipe.

2. The locatable gas distribution system of claim 1 wherein the thermoplastic material comprises a polyethylene resin.

3. The locatable gas distribution system of claim 1 wherein the ferrite particles each comprise at least one of strontium ferrite and barium ferrite.

4. The locatable gas distribution system of claim 3 wherein the ferrite particles comprise about 12% to about 24% concentration by weight of the pipe.

5. The locatable gas distribution system of claim 3 wherein the ferrite particles comprise about 17% to about 24% concentration by weight of the pipe.

6. The locatable gas distribution system of claim 1 wherein the magnetic pattern signature comprises a sinusoidal signature having a constant predetermined period.

7. The locatable gas distribution system of claim 6 wherein the period is 10 feet.

8. A method for producing a locatable pipe comprising:
producing a thermoplastic resin;
adding a plurality of ferrite particles to the thermoplastic resin during a compounding process to form a mixture of the thermoplastic resin and the ferrite particles;
forming the locatable pipe by extruding the mixture; and
directionally magnetizing the ferrite particles to produce a magnetic pattern signature having a constant magnitude and a constant change in a direction along a length of the pipe.

9. The method of claim 8 further comprising the step of moving the locatable pipe through a bore formed in a magnetizer.

10. The method of claim 8 wherein the ferrite particles are embedded in the pipe during the forming step.

11. The method of claim 8 wherein the ferrite particles comprise at least one of strontium ferrite and barium ferrite.

12. The method of claim 8 wherein the ferrite particles comprise about 12% to about 24% concentration by weight of the mixture.

13. The method of claim 8 wherein the ferrite particles comprise about 17% to about 24% concentration by weight of the mixture.

14. The method of claim 8 wherein a magnetizer directionally magnetizes the ferrite particles to produce the magnetic pattern signature.

15. The method of claim 14 wherein the magnetizer comprises a plurality of magnets each rotatable around a bore formed in the magnetizer.

16. The method of claim 15 wherein an inner wall of the magnetizer forming the bore has a circumference slightly greater than an outer circumference of the locatable pipe.

17. The method of claim 14 wherein the magnetizer comprises a modified Halbach dipole.

18. The method of claim 14 wherein the magnetizer produces a magnetic field measuring at least about 6000 gauss.

19. The method of claim 15 wherein each magnet comprises a niodynium-iron-boron magnet.

20. The method of claim 8 wherein the magnetic pattern signature comprises a sinusoidal signature having a constant periodicity.

21. The method of claim 20 wherein the sinusoidal signature has a period of about 10 feet.

22. A device for magnetizing a pipe comprising:
an extrusion means for extruding a plastic material comprising a plurality of magnetizable particles and forming a plastic pipe; and
a magnetizing means for magnetizing the magnetizable particles to create a magnetic pattern signature about a periphery of the plastic pipe, wherein the magnetic pattern signature having a constant magnitude and a change in a direction along a length of the plastic pipe.

23. The device of claim 22 wherein the magnetizing means to comprises a rotation means for rotating the magnetizing means around the periphery of the plastic pipe.

24. The device of claim 22 wherein the magnetizing means comprises a modified Halbach dipole.

25. The device of claim 22 wherein the magnetizing means produces a magnetic field measuring at least about 6000 gauss.

26. The device of claim 22 wherein the magnetizing means comprises at least one niodynium-iron-boron magnet.

27. A locatable gas distribution system comprising:
a pipe formed of a polyethylene resin; and
a plurality of ferrite particles embedded in the polyethylene resin, the ferrite particles comprising about 12% to about 24% concentration by weight of the pipe,
wherein the pipe having a sinusoidal magnetic pattern signature, the sinusoidal magnetic pattern signature having a constant magnitude and a constant change in a direction along a length of the pipe.

28. The locatable gas distribution system of claim 27 wherein each ferrite particle comprises at least one of strontium ferrite and barium ferrite.

29. The locatable gas distribution system of claim 27 wherein each ferrite particle has a disc-shaped periphery.

30. The locatable gas distribution system of claim 27 wherein the ferrite particles have an average diameter of about 20 μm.
